(19) United States
(12) Patent Application Publication
(10) Pub. No.: US 2025/0243375 A1
(43) Pub. Date: Jul. 31, 2025

(54) PRINTING MATERIAL INCLUDING SALEN COMPOUND

(71) Applicant: Hewlett-Packard Development Company, L.P., Spring, TX (US)

(72) Inventors: Kyeonghwan CHOI, Seongnam Si (KR); Jinmo HONG, Seongnam Si (KR)

(21) Appl. No.: 18/704,174

(22) PCT Filed: Oct. 28, 2021
(86) PCT No.: PCT/US2021/057073

§ 371 Date: Apr. 24, 2024

(51) Int. Cl. C09D 11/50; B41J 2/175; C09D 11/037; C09K 11/06

(52) U.S. Cl. CPC C09D 11/50; C09D 11/037; C09K 11/06; B41J 2/17503; C09K 2211/1007; C09K 2211/1014

(57) ABSTRACT

A printing material particle for a printing apparatus may include a colorant, a binder resin, and a metal-salen complex compound. The metal-salen complex compound may absorb ultra-violet (UV) light to emit visible light to be fluorescent.

### BACKGROUND

A printing apparatus performs printing, such as forming an image on a print medium or forming an object. A printing apparatus may use printing material to perform printing. For example, a printing apparatus as an image forming apparatus may use printing material to form the image on a surface such as a surface of a print medium. For example, the printing material may be supplied to the electrostatic pattern such as the latent image to form the image that is visible. Printing material manufactured by an original equipment manufacturer (OEM), may have a characteristic, property or quality that may enable a higher degree of freedom in terms of, for example, quality, reliability. and productivity in operating a printing apparatus corresponding to the OEM printing material.

### BRIEF DESCRIPTION OF THE DRAWINGS

FIGS. 1-4 illustrate graphs indicating degrees of light intensity emitted by printing material particles as printing material particles, according to an example.

### DETAILED DESCRIPTION

According to an example, the expression “printing apparatus” as used herein includes an apparatus that processes printing data generated at a terminal such as a computer communicating through a wired connection or wirelessly, which may be a computer for personal and/or business use, a remote server communicating data across a network or the internet, and/or a wireless mobile device such as a smartphone or tablet, to perform printing on or in a medium or in a space. An example of the printing apparatus may include a particulate-based printing apparatus, liquid-based printing apparatus, 2D printing apparatus and 3D printing apparatus.

For example, as an example of a printing apparatus may include an image forming apparatus, which may be used to form an image, such as hardcopy documents, for example, from electronic data. For example, an image forming apparatus may include a toner-based image forming apparatuses. In an electrophotographic image forming apparatus, a pattern of electric charges is formed corresponding to the image to be printed. Printing material such as charged toner particles is then attracted to the image pattern to develop the image. The image can then be transferred to a print medium, such as a sheet of paper. The toner can then be securely attached to the print medium.

Printing material is material used to print an image or an object using 2D printing technologies, 3D printing technologies, or any combination thereof. Different materials, types or forms of materials may be used as printing material. For example, printing material may be in a solid, liquid, colloidal, or gaseous form, or any combination thereof. For example, a solid form of printing material may include printing toner particulates, particulates for other applications, and a cable form, and a liquid form of printing material may include liquid-based ink such as ink for ink-jet printing. For example, printing material may be in a liquid form that may be curable to a different form such as a solid.

For example, printing material may be small-sized particles, which may have a particle size distribution, and a color gamut to obtain a quality image. For example, printing material such as toner particles provided by other than original equipment manufacturer (“OEM”) may not be manufactured properly for a design of an image forming apparatus and may have a particle size distribution out of this particle size distribution range. For example, since toner particles provided by other than an OEM may include a binder resin having a relatively low glass transition temperature, without sufficiently meeting the requirements for the fusing performance. toner particles provided by other than an OEM may have poor heat storage ability, causing, for example, image contamination or toner solidification

Accordingly, printing materials provided by other than an OEM may worsen the durability of components of an electrophotographic printing apparatus and may cause deterioration of reproducibility of a dot/line, thus resulting in inferior image quality. Printing material provided by an original equipment manufacturer (“OEM”), may have a characteristic, property or quality that may enable a higher degree of freedom in terms of, for example, quality, reliability, and productivity in operating a printing apparatus corresponding to the OEM printing material.

Therefore, there may be a demand for a mean for discriminating printing materials provided by other than an OEM from printing materials provided by an OEM.

According to an example, printing material may be labeled to indicate the authenticity of the printing material or that the printing material is provided by an OEM.

According to an example, printing material may be labeled for other various types of indications. For example, printing material may be labeled to indicate a purpose of a printed image or a printed object. For example, a document or an image printed with printing material labeled with an indication may be tagged with the label to indicate a security level or a security clearance level of the printed.

According to an example, a variety of methods may be used to label the printing material. For example, a variety of material types having a property to indicate the labeling may be added to the printing material. For example, a fluorescent material or a luminescent material may be added to the printing material to label the printing material.

For example, as labeling material for distinguishing the printing material provided by an OEM from other printing material, a fluorescent material or a luminescent material may be added to the printing material.

Accordingly, printing material added with the labeling material such as toner particles may indicate discriminability, distinction, purpose or information while meeting compatibility between the labeling material components of printing material, such as components in a toner particle, which may include a binder resin, a colorant, a releasing agent, etc.

According to an example, a printing material for a printing apparatus may include a binder resin. According to an example, a printing material for a printing apparatus may include a metal-salen complex compound. According to an example, a printing material for a printing apparatus may include a metal-salen complex compound to absorb ultra-violet (UV) light to emit visible light to be fluorescent.

According to an example, the metal-salen complex compound may have a molecular structure as follows:

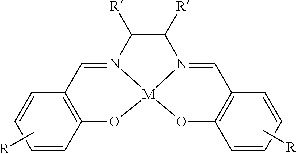

where M represents metal cation, (for example, Al, Fe, Mg, or Zn); R each represents, a hydrogen atom, an alkyl group, an alcohol group, a carboxyl group, or an ester group; and R′ each represents a hydrogen atom, an alkyl group, an alcohol group, a carboxyl group, or an ester group.

According to an example, a printing apparatus may include a printing device to perform printing using printing material, where the printing material may include a metal-salen complex compound to absorb ultra-violet (UV) light to emit visible light to be fluorescent.

According to an example, a printing material may be in form of a particle. According to an example, a printing material particle for a printing apparatus may include a colorant. According to an example, a printing material particle for a printing apparatus may include a binder resin, According to an example, a printing material particle for a printing apparatus may include a metal-salen complex compound. According to an example, a printing material particle for a printing apparatus may include a metal-salen complex compound to absorb ultra-violet (UV) light to emit visible light to be fluorescent.

According to an example, the metal-salen complex compound may have Schiff base moiety.

According to an example, the metal-salen complex compound may have a molecular structure as follows:

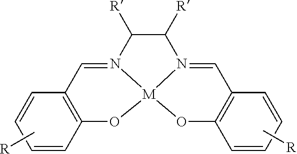

where M represents a metal cation (for example, Al, Fe, Mg, or Zn); R each represents, a hydrogen atom, an alkyl group, an alcohol group, a carboxyl group, or an ester group; and R′ each represents a hydrogen atom, an alkyl group, an alcohol group, a carboxyl group, or an ester group.

According to an example, the metal-salen complex compound may be embedded in the printing material particle.

According to an example, the metal-salen complex compound may be attached on a surface of the printing material particle.

According to an example, an amount of the metal-salen complex compound embedded within the printing material particle may be equal to or more than about 0.5 parts by weight and less than about 3.0 parts by weight of the metal-salen complex compound per 100 parts by weight of the binding resin.

According to an example, an amount of the metal-salen complex compound embedded within the printing material particle may be equal to or more than about 0.1 parts by weight and less than about 0.6 parts by weight of the metal-salen complex compound per 100 parts by weight of printing material.

According to an example, the metal-salen complex compound may absorb the ultra-violet (UV) light having a peak wavelength in a first wavelength range of from about 200 nm to about 230 nm, to emit the visible light.

According to an example, the metal-salen complex compound may absorb the ultra-violet (UV) light to emit the visible light having a peak wavelength in a second wavelength range of from about 400 nm to about 450 nm or a third wavelength range of from about 625 nm to about 675 nm.

According to an example, a printing material cartridge couplable to a printing apparatus may include a printing material particle to form an image, the printing material particle including a binder resin and a metal-salen complex compound to absorb ultra-violet (UV) light to emit visible light to be fluorescent.

For example, in case of printing material being toner particles, the toner particles as the printing material may be small-sized particles, which may have a particle size distribution, and a color gamut to obtain a quality image. For example, toner particles not manufactured properly for a design of an image forming apparatus as a printing apparatus, such as a non-OEM toner particles may have a particle size distribution out of this particle size distribution range. For example, non-OEM toner particles may include a binder resin having a relatively low glass transition temperature, barely to meet the requirements for the fusing performance. Non-OEM toner particles may have poor heat storage ability, causing, for example, image contamination or toner solidification. Accordingly, non-OEM printing material may worsen the durability of components of a printing apparatus. For example, in case of an image forming apparatus based on toner particles as printing material, non-OEM toner particles may cause deterioration of reproducibility of a dot/line, thus resulting in inferior image quality. Therefore, there may be a demand for a means for discriminating non-OEM printing materials from an authentic printing materials.

As a labelled material for discriminating the non-OEM printing material from the OEM printing material, use of a fluorescent material or a luminescent material may be taken into account. Accordingly, printing material labeled with the fluorescent material or the luminescent material may indicate that that printing material is from an OEM by being fluorescent or luminescent.

According to an example, printing material may be a toner for electrophotography. According to an example, the printing material may be in form a particle that may include a binder resin, a colorant, and a releasing agent. For example, the printing material particle may further include an external additive attached to a surface of the printing material particle.

According to an example, as an example of printing material, the printing material particle may include a colorant. The printing material particle may include a binder resin. The printing material particle may include a releasing agent.

According to an example, the printing material particle may include a core or core particle and an external additive attached to the surface of the core particle.

For example, the printing material particle may include a core or core particle and a shell structure.

For example, the printing material particle may include a core or core particle, a shell structure and an external additive attached to the surface of the core particle.

According to an example, the printing material particle, the core or the core particle may include a colorant. The core or the core particle may include a binder resin. The core or the core particle may include a releasing agent.

According to an example, a variety of material types may be included as the binder resin. For example, the material types may include styrenic resin, acrylic resin, vinyl resin, polyolefin resin, polyether-based polyol resin, phenolic resin, silicone resin, polyester resin, epoxy resin, polyamide resin, polyurethane resin, or polybutadiene resin, or any combination thereof. According to an example, the binder resin may include one of the listed material types. For example, the resin may include a plurality of the listed material types.

According to an example, a variety of the styrenic resin may be included in the binder resin. For example, the variety of the styrenic resin may include polystyrene; a homopolymer of styrene with a substituent, such as poly-p-chlorostyrene or polyvinyltoluene; a styrene-based copolymer, such as a styrene-p-chlorostyrene copolymer, a styrene-vinyltoluene copolymer, a styrene-vinylnaphthalene copolymer, a styrene-acrylic acid ester copolymer, a styrene-methacrylic acid ester copolymer, a styrene-methyl α-chloromethacrylate copolymer, a styrene-acrylonitrile copolymer, a styrene-methyl vinyl ether copolymer, a styrene-vinyl ethyl ether copolymer, a styrene-vinyl methyl ketone copolymer, a styrene-butadiene copolymer, styrene-isoprene copolymer, or a styrene-acrylonitrile-indene copolymer, or any combination thereof.

According to an example, a variety of the acrylic resin may be included in the binder resin. For example, the variety of the acrylic resin may include an acrylic acid polymer, a methacrylic acid polymer, a methyl methacrylate polymer, a methacrylic acid methyl ester copolymer, a methyl α-chloromethacrylate polymer, or an α-chloro methacrylic acid methyl ester copolymer, or any combination thereof.

According to an example, a variety of the vinyl or polyolefin resin may be included in the binder resin. For example, the variety of the vinyl or polyolefin resin may include a vinyl chloride polymer, an ethylene polymer, a propylene polymer, an acrylonitrile polymer, or a vinyl acetate polymer, or any combination thereof.

According to an example, the polyester resin may be prepared via reaction between an aliphatic, alicyclic, or aromatic polybasic carboxylic acid or alkyl ester and polyhydric alcohol via direct esterification or trans-esterification. An Example of the polybasic carboxylic acid may include phthalic acid, isophthalic acid, terephthalic acid, tetrachlorophthalic acid, chlorophthalic acid, nitrophthalic acid, p-carboxyphenylacetic acid, p-phenylene-2-acetic acid, m-phenylenediglycolic acid, p-phenylenediglycolic acid, ophenylenediglycolic acid, diphenylacetic acid, diphenyl-p,p?-dicarboxylic acid, naphthalene-1,4-dicarboxylic acid, naphthalene-1,5-dicarboxylic acid, naphthalene-2,6-dicarboxylic acid, anthracenedicarboxylic acid, or cyclohexane dicarboxylic acid, or any combination thereof. Also, in addition to the dicarboxylic acid, a polybasic carboxylic acid such as trimellitic acid, pyromellitic acid, naphthalene tricarboxylic acid, naphthalene tetracarboxylic acid, pyrene tricarboxylic acid, and pyrene tetracarboxylic acid may be used. Also, derivatives of a carboxylic acid in which the carboxylic group thereof is reacted to form an anhydride, oxychloride, or ester group may be used. Among them, terephthalic acid or lower esters thereof, diphenyl acetic acid, cyclohexane di-carboxylic acid, or the like may be used. The lower ester refers to an ester of aliphatic alcohol having one to eight carbon atoms. Examples of the polyhydric alcohol may include an aliphatic diol such as ethylene glycol, diethylene glycol, triethylene glycol, propylene glycol, butane diol, hexane diol, neopentyl glycol, or glycerine; an alicyclic diol such as cyclohexane diol, cyclohexane dimethanol, or hydrogen-added bisphenol A; and an aromatic diol such as ethylene oxide adduct of bisphenol A or propylene oxide adduct of bisphenol A. One or more than one of the polyhydric alcohol may be used. Among these polyhydric alcohols, an aromatic diol and an alicyclic diol may be used. For example, an aromatic diol may be used. In addition, a polyhydric alcohol having three or more-OH groups, such as glycerin, trimethylol propane, or pentaerythritol may be used together with the diol to have a cross-linked structure or a branched structure to increase fixability or fusability of the printing material.

According to an example, the number average molecular weight of the binder resin may be in the range of about 700 to about 1,000,000 g/mol or about 10,000 to about 500,000 g/mol. According to an example, the binder resin may include a combination of a high molecular weight binder resin and a low molecular weight binder resin. For example, a number average molecular weight of the high molecular weight binder resin may be, for example, from about 100,000 to about 500,000 g/mol, and a number average molecular weight of the low molecular weight binder resin may be, for example, from about 1,000 to about 100,000 g/mol. According to an example, the two types of binder resins having different molecular weights may have respective functions. For example, the low molecular weight binder resin may have little molecular chain entanglements, thereby contributing to fusability and gloss. For example, the high molecular weight binder resin may maintain a certain level of elasticity even at a high temperature due to many molecular chain entanglements, thereby contributing to anti-hot offset properties.

For example, a number-average molecular weight of the binder resin may be in a range of about 700 to about 1,000,000, or about 10,000 to about 200,000.

According to an example, a variety of materials may be used for the colorant. For example, the colorant may include a black colorant, a yellow colorant, a magenta colorant, a cyan colorant, or any combination thereof.

For example, a material for the black colorant may include carbon block, aniline black, or a combination thereof.

For example, a material for the yellow colorant may include a condensed nitrogen compound, an isoindolinone compound, an anthraquine compound, an azo metal complex, an allyl imide complex, or a combination thereof. For example, materials for the yellow colorant may include C.I. (color index) Pigment Yellow 12, 13, 14, 17, 62, 74, 83, 93, 94, 95, 109, 110, 111, 128, 129, 147, 168, or 180.

For example, a material for the magenta colorant may include a condensed nitrogen compound, an anthraquine compound, a quinacridone compound, a base dye lake, a naphtol compound, a benzoimidazole compound, a thioindigo compound, a perylene compound, or any combination thereof. More particular non-limiting examples of the magenta colorant may be “C.I. Pigment Red” 2, 3, 5, 6, 7, 23, 48:2, 48:3, 48:4, 57:1, 81:1, 122, 144, 146, 166, 169, 177, 184, 185, 202, 206, 220, 221, or 254.

For example, a material for the cyan colorant may include a copper phthalocyanine compound or a derivative thereof, an anthraquine compound, a base dye lake, or any combination thereof. More particular non-limiting examples of the cyan colorant may be “C.I. Pigment Blue” 1, 7, 15, 15:1, 15:2, 15:3, 15:4, 60, 62, or 66.

According to an example, a content of the colorants in the printing material particle may be in a range of about 0.1 parts by weight to about 20 parts by weight or a range of about 2 parts by weight to about 10 parts by weight with reference to 100 parts by weight of the binder resin.

According to an example, a variety of materials may be used for the releasing agent. For example, the material for the releasing agent may include a polyethylene-based wax, a polypropylene-based wax, a silicone-based wax, a paraffin-based wax, an ester-based wax, a carnauba wax, a metallocene-based wax, or any combination thereof.

According to an example, the releasing agent may have a melting point in a range of about 50° C. to about 150° C.

According to an example, the amount of the releasing agent included in the core particle may be, for example, from about 1 part by weight to about 20 parts by weight, or from about 1 part by weight to about 10 parts by weight, based on 100 parts by weight of the binder resin. For example, the releasing agent may prevent the printing material particles from sticking to a heating roller of a fixing device.

According to an example, a content of the releasing agent in the printing material particle or in the printing material particle core may be in a range of about 1 part by weight to about 20 parts by weight of the corresponding printing material particle composition or the corresponding printing material particle core composition. For example, the content of the releasing agent in the printing material particle or in the printing material particle core may be in a range of about 1 part by weight to about 10 parts by weight with reference to 100 parts by weight of the binder resin.

According to an example, the core particles may be prepared by a variety of methods. For example, the core particles may be prepared by a pulverization process, an aggregation process, a spraying process, or any combination thereof. For example, the pulverization process may be performed by, for example, pulverizing after melting and mixing a binder resin, a colorant, and a releasing agent. The aggregation process may be performed by, for example, mixing a binder resin dispersion, a colorant dispersion, and a releasing agent dispersion; aggregating these particles of the binder resin, the colorant, and the releasing agent; and combining the resulting aggregates.

According to an example, a volume average particle diameter of the core particles may be controlled, set, or produced based on a design or purpose of the printing material particles. For example, a volume average particle diameter of the core particles may be controlled, set, or produced to be, from about 4 micrometer (μm) to about 20 μm or from about 5 μm to about 10 μm.

According to an example, a shape of the core particles may be controlled or targeted. For example, the shape of the core particles may be controlled or targeted to be a sphere, substantially sphere, or closer to be a sphere, to increase charging stability of the printing material or dot reproducibility of a print image. For example, the core particles may have or may be controlled or targeted to have a sphericity in a range of, for example, about 0.90 to about 0.99.

According to an example, the printing material particle or the core particle of the printing material particle may be formed or produced by a variety of formation methods or production methods. For example, the printing material particle or the core particle of the printing material particle may formed by an emulsion-aggregation (“EA”) process or method.

According to an example, the printing material particle may include a shell layer. For example, the shell layer may be formed on a surface of the core particle of the printing material particle. For example, the shell layer may surround a core particle. According to an example, a variety of material types may be included in the shell layer. For example, the shell layer may include a binder resin for the shell layer. For example, the binder resin for a shell layer may include a styrenic resin, an acrylic resin, a vinyl resin, a polyether polyol resin, a phenolic resin, a silicone resin, a polyester resin, an epoxy resin, a polyamide resin, a polyurethane resin, polybutadiene resin, or any combination thereof. For example, the shell layer may include the styrenic resin, which may include polystyrene; a homopolymer of styrene with a substituent, such as poly-p-chlorostyrene or polyvinyltoluene; a styrene-based copolymer, such as a styrene-p-chlorostyrene copolymer, a styrene-vinyltoluene copolymer, a styrene-vinylnaphthalene copolymer, a styrene-acrylic acid ester copolymer, a styrene-methacrylic acid ester copolymer, a styrene-methyl α-chloromethacrylate copolymer, a styrene-acrylonitrile copolymer, a styrene-methyl vinyl ether copolymer, a styrene-vinyl ethyl ether copolymer, a styrene-vinyl methyl ketone copolymer, a styrene-butadiene copolymer, styrene-isoprene copolymer or a styrene-acrylonitrile-indene copolymer; or any combination thereof. For example, the shell layer may include the acrylic resin, which may include an acrylic acid polymer, a methacrylic acid polymer, a methacrylic acid methyl ester copolymer, an α-chloro methacrylic acid methyl ester copolymer, or any combination thereof. For example, the shell layer may include a vinyl resin, which may include a vinyl chloride polymer, an ethylene polymer, a propylene polymer, an acrylonitrile polymer, a vinyl acetate polymer, or any combination thereof. According to an example, a number-average molecular weight of the binder resin for a shell layer may be controlled, targeted or achieved. For example, the number-average molecular weight of the binder resin for a shell layer may be in a range of about 700 to about 1,000,000, or about 10,000 to about 200,000. According to an example, the binder resin for a shell layer may be identical to or different from the binder resin for the core particle.

According to an example, an external additive may be attached to the surface of the printing material particle, the core particle, the shell layer, or any combination thereof. According to an example, the external additive may be added or attached to the surface of the printing material particle, the core particle, the shell layer to modify, alter, change, or control a surface characteristic or a property. For example, the external additives is to modify, alter, change, or control printing material particles from sticking together thereby maintaining fluidity of printing material powder. We have noted the behavior of external additives as one of the causes of a change in charge amount of the printing material.

According to an example, the external additive may include a variety of materials types. For example, the external additive may include an inorganic particle. For example, the external additive may include a silica particle and a titanium-containing particle. For example, the external additive may include fumed silica, sol-gel silica or any combination thereof.

According to an example, the size of the inorganic particle, such as an average size of the particles may be controlled or set. For example, when the primary particle size or the average size of the inorganic particles such as silica particles exceed a certain size, printing material particles having the inorganic particles externally added the surface may be relatively difficult to pass through a printing material particle transport management or conveying system such as a developing blade. For example, a selection phenomenon of printing material may occur. For example, as usage time of a printing material cartridge increases, a particle size of the printing material particles remaining in the printing material cartridge may gradually increase due to the selection phenomenon.

According to an example, depending on the size of the external additive, charge of printing material may decrease or thus the thickness of a printing material layer developing an electrostatic latent image may increase. For example, when the primary particle size of the inorganic particles exceeds a certain size, a probability of the inorganic particles to be separated from the printing material particles may relatively increase due to stress applied to printing material particles from a member such as a feed roller. The inorganic particles separated from printing material particles may contaminate a charging member or a latent image carrier. According to an example, when the primary particle size of the inorganic particles is below a certain size, the inorganic particles may be likely buried into the core particles due to shearing stress applied such as by a developing blade. When the inorganic particles are buried into the core particles, the inorganic particles may lose a function as an external additive. Accordingly, adhesion between the printing material particles and the surface of a photoconductor may be undesirably increased. This may lead to reduction in cleaning ability and transferability of the printing material.

According to an example, a volume average primary particle size of the inorganic particles may be in a range of about 10 nanometer (nm) to about 80 nm, in particular in a range of about 30 nm to 80 nm, or in a range of about 60 nm to about 80 nm.

According to an example, the inorganic particles such as silica particles may include particles having a volume average particle size of about 30 nm to about 100 nm and small inorganic particles having a volume average particle size of about 5 nm to about 20 nm. The relatively small inorganic particles may increase charging stability of the printing material particle by providing a larger surface area compared to that of the relatively large inorganic particles. In addition, the small inorganic particles may be attached to the core particle such that the small inorganic particles are arranged between the large inorganic particles. Thus, even when a shearing stress is exerted on the printing material particle from outside, the shearing stress is not transmitted to the small inorganic particle. That is, the shearing stress exerted on the printing material particle from the outside is concentrated on the large silica particle. Accordingly, the small silica particle may not be buried in the core particle and maintain an effect in which the charging stability of the printing material particle improves. When content of the small inorganic particles is too small compared to that of the large inorganic particles, durability of the printing material may deteriorate and the effect in which the charging stability of the printing material particle improves may be small. When content of the small inorganic particles is too large, the charging member or the latent image carrier may be contaminated due to poor cleaning. A weight ratio of the large silica particle to the small silica particle may be, for example, about 0.5:1.5 to about 1.5:0.5.

According to an example, a core particle and a shell layer may be prepared by using a coagulation method using a coagulant. For example, the coagulant may be poly silicate iron, an aluminum-based coagulant, or other metal cation-based coagulant.

According to an example, printing materials such as printing material particles may include a material or compound that is fluorescent.

According to an example, types of fluorescent compound or pigment included in printing material particles may degrade or lose fluorescent property during the printing material particle formation, the core particle formation, or the shell layer formation. For example, types of fluorescent compound or pigment included in printing material particles may degrade or lose fluorescent property during the relatively high temperature during an emulsion-aggregation (“EA”) process. According to an example, to circumvent the fluorescent property degradation or to preserve or maintain the fluorescent property, the fluorescent material may be added to a surface of the printing material particle as a surface additive.

According to an example, a surface additive may alter the surface characteristics of the printing material particle, and a type of an amount that can be added as the surface additive may be affected or based by a degree of the surface characteristic change.

For example, a surface characteristic or property of printing material particles, such as printing material particles with a shell layer, may affect charging uniformity, charging stability, transferability, or cleaning ability to the printing material particles. For example, one factor that may affect the surface characteristics of printing material particles is an external additive added to a surface of the printing material particle. For example, one of the external additive is to maintain fluidity of printing material particles by preventing the printing material particles from sticking together. The external additive may also affect charging uniformity, charging stability, transferability, and cleaning ability. As the external additive, silica particles or titanium oxide particles has been used.

For example, amounts of some external additives may influence obtaining charging uniformity. For example, fumed silica has a relatively higher negative polarity, and an excessive charge-up phenomenon may relatively more frequently occur in a printing material that has fumed silica externally added thereto.

According to an example, printing materials such as printing material particles may include a metal-salen complex compound.

According to an example, printing materials such as printing material particles may include a metal-salen complex compound having a Schiff base ligand.

According to an example, printing materials such as printing material particles may include a metal-salen complex compound having a Schiff base ligand as a fluorescent material.

According to an example, a printing material particle may include a metal-salen complex compound within the printing material particle. According to an example, a printing material particle may include a metal-salen complex compound added to an outer surface of the printing material particle. According to an example, a printing material particle may include a metal-salen complex compound in a particle core or core layer, a particle shell layer, or on an external surface of the printing material particle, or any combination thereof. For example, a metal-salen complex compound may be distributed across the printing material particle or over a region within the printing material particle.

According to an example, the metal-salen complex may have relatively higher heat stability than some of the other non-metal-salen complex compound that is not fluorescent.

According to an example, the metal-salen complex can be synthesized along with the printing material particle formation such as the toner particle formation or the core particle formation, during the emulsion and aggregation (EA) process to form the printing material particle core.

For example, the EA process may occur at a relatively high temperature, and a fluorescent property of a fluorescent compound that is not a metal-salen complex compound may be degraded or lost due to the heat from the EA process. As a way of circumventing the heat degradation, the fluorescent compound may be added as an external surface additive to the printing material particle such as toner particle. However, such an addition may alter, modify or change the surface characteristics of the printing material particle.

In comparison, formation of the metal-salen complex compound may occur concurrently with the printing particle formation during the EA process and does not degrade or lose fluorescent property as much during the EA process. For example, a salen compound may be adhered to the tail end of a polymer of the binder resin to form a toner particle during the EA process and a metal cation-based coagulant for forming the printing material particle during the EA process may together form a metal-salen complex compound during the EA process. As a result, the metal-salen complex can be included in the printing material particle such as a particle core of the printing material particle, a shell layer of the printing material particle, or any combination thereof. At the same time, the metal-salen complex can also be added to the shell structure or to the surface of the printing material particle, allowing more applicability and more amounts of the fluorescent material to the printing material particle.

According to an example, the EA process may include an emulsion phase and an aggregation phase. According to an example, printing material such as printing material particles may be manufactured by the EA process adding a metal cation, such as aluminum, iron, magnesium, zine, or any combination thereof, as a coagulant, for example, during the emulsion phase. During the aggregation phase of the EA process, metal ions can be aggregated with other ingredient that has an affinity to metal ion. When the Schiff base structure, such as the Schiff based structure added to a salen compound, is added to the process or added to a part of a resin such as a binder resin in EA process, the Schiff base structure, such as the Schiff based structure added to a salen compound, can bind to a metal cation. According to an example, the Schiff base structure, such as the Schiff based structure added to a salen compound, may be added after the particle formation or the EA process and may be present on the surface of the formed particle during the EA process.

According to an example, depending on the form in which the Schiff base moiety, such as the Schiff based structure added to a salen compound in printing material particle, final printing material can exhibit fluorescence characteristics by absorption due to such a coordination structure or its nature.

According to an example, depending on the Schiff base moiety, such as the Schiff based structure added to a salen compound in printing material particle, a sale compound structure, a type of metal cation, or any combination thereof may determine a range of the light wavelength to be absorbed or a range of the fluorescent light wavelength to be emitted. For example, the metal-salen complex compound may absorb a UV light and emit a visible light. For example, the metal-salen complex compound may absorb light having a wavelength in a range from about 400 nm to about 650 nm. For example, the metal salen complex compound may emit light having a wavelength in a range from about 200 nm to about 350 nm.

According to an example, due to the coordination structure of the coagulant and the resin in the printing material particle, it may have the property or characteristic of exhibiting fluorescence corresponding to the wavelength of the light being incident or being absorbed. According to an example, the light being emitted as a result of the incident or absorbed light may be visible light that may be recognized by human eyes without using a device to detect the fluorescent light.

According to an example, the fluorescent property of emitting visible light may be implemented in different applications. For example, the visible fluorescent property of the printing material particle may enable identify the genuine printing material without necessity or need of a specialized device to detect fluorescence, For example, the visible fluorescent property transferred into the printed image or the printed object may allow identification of information associated with the printed image or the printed object, such as a location of the printing a type of printed image or the printed object, for example, for a security indication.

According to an example, the printing material particle such as the printing material particle may include a compound having Schiff base moiety (C═N bond adjacent to alkyl group such as an aromatic ring) represented by the Salen ligand structure, to give printing material fluorescence properties. For example, Schiff base moiety can be represented by salen as shown in Formula 1:

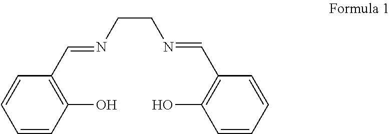 [SMILES: Oc1ccccc1/C=N/CC/N=C/c1ccccc1O]

According to an example, These functional groups can selectively form a complex structure with a metal cation such as Al(III) during the EA process as shown in formula 2 below:

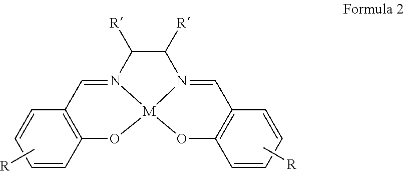

where M may represent a metal cation (For example, Al, Fe, Mg, or Zn); R each may represents a functional group, which may include a hydrogen atom, an alkyl group, an alcohol group, a carboxyl group, or an ester group; and R′ each may represent a functional group, which may include a hydrogen atom, an alkyl group, an alcohol group, a carboxyl group, or an ester group. According to an example, the metal cation may be selected form a variety of metal cations. For example, the metal cation may be selected from a group of metal elements comprising Aluminum (Al), Iron (Fe), Magnesium (Mg), or Zinc (Zn).

According to an example, a fluorescence characteristic or property of the metal-salen complex, such as the peak fluorescent light wavelength, may be determined by the molecular arrangement of the metal-salen complex compound, such as Schiff base moiety, the metal cation element, other structural arrangement, or any combination thereof.

According to an example, the metal-salen complex compound may be added inside the printing material particle, the core particle of the printing material particle, or the shell layer of the printing material particle. According to an example, the metal-salen complex compound may be added onto the surface of the printing material particle such as the printing material particle. For example, the metal-salen complex compound may be added onto the surface of the printing material particle and inside the printing material particle, the core particle of the printing material particle, or the shell layer formed on the core particle of the printing material particle. According to an example, the metal-salen complex may be distributed across the printing material particle or over a region in the printing material particle or on the printing material particle.

According to an example, the printing material having the Schiff base structure, such as a salen compound having the Schiff base structure, may absorb energy in a wavelength, such as a wavelength in a range of from about 200 nm to about 350 nm, to emit fluorescent light or express fluorescence at a wavelength, such as a wavelength from about 400 nm to about 640 nm. According to an example, the fluorescence of the Schiff base structure, such as may be due to a molecular or chelating structure.

According to an example, expressing fluorescence even with a small amount remaining inside the dried printing material may allow more applicability of the fluorescence.

According to an example, enabling the identification of the non-OEM printing material in a more accessible manner, such as by checking the visible fluorescence, may help reduce service costs associated with non-OEM printing materials.

The light absorption and the light emission spectrum of a metal-salen complex may be determined based on a type of metal ion being paired with the salen compound. For example, the printing material particle including a metal-salen complex may exhibit the absorption light spectrum in a range of from about 200 nm to about 250 nm and the emission light spectrum in a range of from about 400 nm to about 675 nm, for example, from about 400 nm to about 650 nm. Because a light wavelength range of from about 400 nm to about 675 nm belongs to a visible light spectrum, such printing material particles may be used to print images with security features, such as identification of the authenticity of the OEM printing material, without requiring a special device or complex lab analysis, or using the printing material particles to mark the images being printed as images to be secured.

For example, the printing material particle including a metal-salen complex may exhibit the absorption spectrum in a range of from about 200 nm to about 230 nm, to emit the visible light. For example, the metal-salen complex compound is to absorb the ultra-violet (UV) light to emit the visible light having a peak wavelength in a second wavelength range of from about 400 nm to about 450 nm or a third wavelength range of from about 625 nm to about 675 nm.

According to an example, to be fluorescent, an example metal-salen complex may have the molecular structure correspond to Formula (2) below:

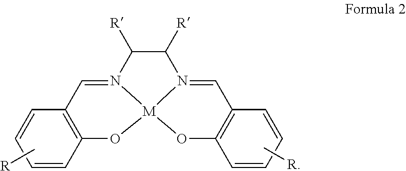

where M may represent a metal cation (for example, Al, Fe, Mg, or Zn); R each may represent a hydrogen atom, an alkyl group, an alcohol group, a carboxyl group, or an ester group; and R′ each may represent a hydrogen atom, an alkyl group, an alcohol group, a carboxyl group, or an ester group.

According to an example, the metal-salen complex can be synthesized along with the printing material particle formation, such as the printing material particle or the core particle of the printing material particle or the shell layer of the printing material particle, and because the metal-salen complex may have a relatively higher heat stability, compared to a non-metal-salen complex compound, the metal-salen complex may be added in more amount or provide more flexibility in terms of adding the metal-salen complex to different portion of the printing material particle. For example, the metal-salen complex can be added to the core particle, the shell layer, the external surface, or any combination thereof, which may allow more flexibility in distributing the metal-salen complex compound in the printing material particle, and which may enable the printing material particle to contain additional amount of the metal-salen complex compound. As a result, the intensity of the fluorescence or a characteristic of the fluorescence may be controlled based on such flexibility in the distribution or the increased amount in the printing material particle. For example, the fluorescence of the printing material particle including the metal-salen complex may be used to detect the authenticity of OEM printing material particles. Because the metal-salen complex compound absorbs UV light and emits visible fluorescent light, a technician may check the authenticity of the printing material particle by checking the visible light being emitted, for example, without necessitating a more complex detection device or without a need to take the printing material particles to a lab for analysis of, for example, a shape or size analysis or composition analysis to identify the authenticity of the printing material particles. For example, printing material containing metal-salen complex compound may be used to print an object or an image with a security or authenticity features. For example, a document or image that require an authentication or security check can be examined by projecting UV light having a corresponding peak wavelength and based on the fluorescence itself, intensity of the fluorescence, a characteristic of fluorescence, or any combination thereof.

The following describes experimental examples and comparative examples according to an example.

### [The Preparation of Salen Based Schiff Base]

To initiate the reaction based on Formula (3) below, 4 milli-liter (mL) of a colorless ethanol solution containing 2,3-dihydroxybenzaldehyde (256.32 milligram (mg), 2.0 milli-mol (mmol)) was slowly added to 4 mL of the ethanol solution containing 2-[0-(1-ethyloxyamide)]oxime-5-methoxyphenol1) (425.05 mg, 2.0 mmol) to form a mixture. The mixture was stirred at 52° C. for 6 hours. After the stirring, the mixture was cooled at room temperature to form a precipitate. After cooling the mixture to room temperature, the precipitate was filtered and washed successively with 3 mL ethanol and then 4 mL of ethanol-hexane (1:4 mixing ratio), respectively. The product was purified with recrystallization from ethanol and dried in vacuum to obtain a yellow powder.

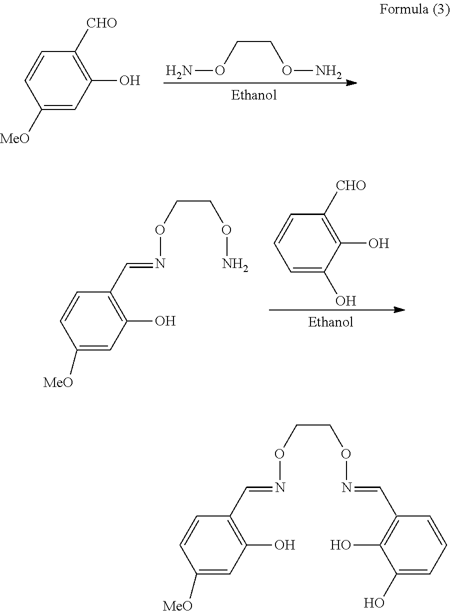 [SMILES: COc1ccc(C=O)c(O)c1 ; NOCCON ; COc1ccc(/C=N/OCCON)c(O)c1 ; O=Cc1cccc(O)c1O ; COc1ccc(/C=N/OCCO/N=C/c2cccc(O)c2O)c(O)c1]

### [Preparing Printing Material Resin and Introducing Salen Derivatives to Printing Material Resin]

In case of L-Type Latex or resin, a mixture of polymerizable monomers (825 g of styrene and 175 g of n-butyl acrylate), 30 g of (3-carboxyethyl acrylate (Sipomer, Rhodia)), 17 g of 1-dodecanethiol as a chain transfer agent (CTA), and 418 g of an aqueous solution of sodium dodecyl sulfate (Aldrich, 2% in water) as an emulsifier were added to a 3 L beaker and the mixture was stirred to prepare a polymerizable monomer emulsion. 16 g of ammonium persulfate (APS) as an initiator and 696 g of an aqueous solution of sodium dodecyl sulfate (Aldrich, 0.4% in water) as an emulsifier were added to a 3 L double jacket reactor heated at about 75° C. The prepared polymerizable monomer emulsion was slowly added dropwise to the double jacket reactor for 2 hours or more while stirring. The mixture was maintained at about 75° C. for about 8 hours. Particles sizes of the prepared latex measured by a light scattering method (Mictotrac) were from about 180 nm to about 250 nm. A solid content of the latex measured by a dry weight loss method was about 42%. A weight average molecular weight (Mw) of the latex measured by gel permeation chromatography (GPC) using the portion of the latex that is soluble in tetrahydrofuran (THF) was about 25,000 g/mol. A glass transition temperature of the latex measured at a second scanning at a heating rate of 10° C./min by a DSC method (PerkinElmer) was about 62° C.

In case of H-Type resin or latex, a mixture of polymerizable monomers (685 g of styrene and 315 g of n-butyl acrylate), 30 g of β-carboxyethyl acrylate (Sipomer, Rhodia), and 418 g of an aqueous solution of sodium dodecyl sulfate (Aldrich, 2% in water) as an emulsifier were added to a 3 L beaker and the mixture was stirred to prepare a polymerizable monomer emulsion. 5 g of ammonium persulfate (APS) as an initiator and 696 g of an aqueous solution of sodium dodecyl sulfate (Aldrich, 0.4% in water) as an emulsifier were added to a 3 L double jacket reactor heated at about 60° C. The prepared polymerizable monomer emulsion was slowly added dropwise to the double jacket reactor for 3 hours or more while stirring. The mixture was maintained at about 75° C. for about 8 hours. Particles sizes of the prepared latex measured by a light scattering method (Horiba 910) were from about 180 nm to about 250 nm. A solid content of the latex measured by a dry weight loss method was about 42%. A weight average molecular weight (Mw) of the latex measured by gel permeation chromatography (GPC) using the portion of the latex that is soluble in tetrahydrofuran (THF) was about 25,000 g/mol. A glass transition temperature of the latex measured at a second scanning at a heating rate of 10° C./min by the DSC method (PerkinElmer) was about 53° C.

In case of the polyester-based resin or latex, 500 g of a polyester resin, 450 g of methyl ethyl ketone (MEK), and 150 g of IPA are put into a 3 L reactor, and then, are stirred at 30° C. by using an semi-moon type impeller, thus obtaining a polyester resin solution. While the polyester resin solution is stirred, an aqueous ammonia solution of 5 wt % is gradually added to the polyester resin solution to adjust a pH of the polyester resin solution to pH 7.5. Then, while the polyester resin solution is stirred, 2,000 g of water are added thereto at a speed of 20 g/min, thus obtaining an emulsion. A solvent is removed from the emulsion by distilling the emulsion under reduced pressure, thereby obtaining a binder resin latex having a solids concentration of 20 wt %.

Salen compound was introduced at the end or side chain of the resin polymer through condensation and hydrolysis. In the case of the Styrene-Acrylate resin, an addition reaction under basic conditions was performed. In case of a polyester, a condensation reaction under acidic conditions was performed.

### [The Preparation of Printing Material Particle Containing Metal-Salen Complex Compound and Other Comparative Material(s)]

For the pigment dispersion preparation, 10 g of sodium dodecyl sulfate as an anionic reactive emulsifier and 60 g of a carbon black pigment were added to a milling bath, and 400 g of glass beads having a diameter of about 0.8 mm to about 1 mm were added thereto. The mixture was milled at room temperature to prepare a dispersion. An ultrasonic homogenizer or a micro fluidizer may be used to disperse the mixture. Particle diameters of the pigment dispersion measured by a light scattering method (Horiba 910) were from about 180 nm to about 200 nm. A solid content of the prepared pigment dispersion was about 18.5%.

In case of the salen derivatives-introduced resin, printing material particle was prepared by an emulsion-aggregation (EA) method.

3000 g of deionized water, 700 g of a latex mixture for core particles (a mixture of 95% of the L-type latex and 5% of the H-type latex), 195 g of the pigment dispersion, and 237 g of a wax dispersion (P787, Chukyo Yushi, Co., Ltd., Solid content: about 30.5%) were added to a 7 L reactor. A mixture of 105 g of nitric acid and 105 g of polysilicato-iron (PSI-025, Suido Kiko Kaisha, Ltd. of Tokyo, Japan) was added to the reactor and the mixture was stirred by using a homogenizer at about 11,000 rpm for 6 minutes, and then 417 g of the latex mixture was further added and the mixture was further stirred for 6 minutes to obtain agglomerates having a size of about 1.5 μm to about 2.5 μm.

The mixture was added to the 7 L double jacket reactor and heated from room temperature to a temperature of about 55° C. (Tg of the latex−5° C.) at a rate of 0.5° C./min. When the particle diameter D50 (Volume) reaches about 6.0 μm, 442 g of the latex mixture (a mixture of 90% of the L-type latex and 10% of the H-type latex) was slowly added thereto for about 20 minutes. When the particle diameter D50 (Volume) reaches about 6.8 μm, the pH of the mixture was adjusted to about 4 by adding 1 mol NaOH. When the pH reaches 4, for Comparative Examples not containing Metal-Salen compounds the 142 g of EDTA solution (10% aqueous solution) is slowly added. Then the pH is raised to 6.5 using NaOH When the particle diameter D50 (Volume) was maintained for 10 minutes, the reactor was heated to about 96° C. After the temperature reaches about 96° C., the pH was adjusted to about 6.0, coalescence was performed for 3 to 5 hours to obtain a secondary agglomerated printing material with a potato-like shape having a particle diameter D50 (Volume) of about 6.5 μm to about 7.0 μm. Then, the agglomerated reaction solution was cooled below the glass transition temperature Tg and the printing material particles were separated by filtration and dried. For Examples 1-6, and Comparative Example 4, which containing indicated amounts of the aluminum-salen complex compound in the printing material core particle as indicated in Table 2 below, the PSI and EDTA were replaced with an aluminum-based coagulant and a Salen compound. The amount of Metal-Salen Complex Compound added as discussed above was about 0.5 weight percent (wt. %), about 1.0 wt. %, about 1.5 wt. %, about 2.0 wt. %, about 2.5 wt. %, and about 3.0 wt. %.

300 g of a latex for forming a shell layer was added to the mixture and the mixture is stirred for an hour, thereby producing core-shell particles. Then, a 1 N NaOH aqueous solution is added to the mixture to adjust a pH of the mixture to 8.5 and the mixture is stirred for 20 minutes. Then, the mixture is heated to 90° C., and then, stirred for 5 hours to coagulate the core-shell particles. Then, the mixture was cooled to a temperature of less than 35° C. Then, the core-shell particles are separated from the mixture and dried.

To externally add inorganic fine particles as external additives to surfaces of untreated dry printing material particles, 100 parts by weight of the untreated printing material particles were added to a mixer (manufactured by DAEWHA TECH IND., model name: KMLS2K), and then 2.0 parts by weight of sol-gel silica having a primary particle diameter of about 70 nm and an apparent density of about 220 g/L and satisfying the specifications shown in Table 2 below (SG50, SUCKYOUNG), 1.0 part by weight of small-diameter fumed silica having a primary particle diameter of about 16 nm and hydrophobicized with diethyldimethyl siloxane (DDS) (AEROSIL®972, EVONIK INDUSTRIES), and 1.0 part by weight of lanthanum strontium titanate (SWL400B, Titan Industry Co., Ltd.) were further added to the mixer. The mixture was mixed in a 2 L stirrer at about 2000 rpm for 30 seconds and then further stirred at about 6000 rpm for 3 minutes to obtain externally added printing material particles. For Examples 6-8 and Comparative Example 3 having the aluminum-salen complex compound were added onto a surface of the printing material particle as an external additive, at amounts indicated in Table 2 below. The aluminum-salen complex compound was added in the additives blending step to add the salen-aluminum complex compound as an external additive.

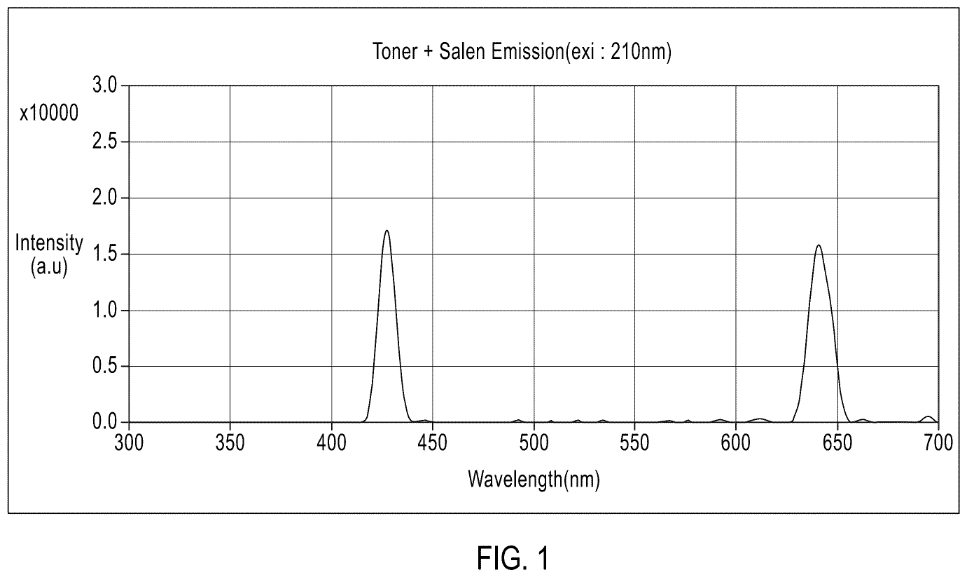

FIG. 1 illustrates a graph indicating a degree of light intensity emitted by printing material particles (y-axis) including 0.5 weight percent (%) of a metal-salen complex compound, with respect to the weight of the printing material particle, within the core particles of the printing material particles in the form substituted for resin, versus a range of light wavelength as indicated on the x-axis, when the printing material particles including the metal-salen complex compound within the core particles absorbs or is excited by the UV light having its peak wavelength of about 210 nm, according to an example. Referring to FIG. 1, printing material particle including the metal-salen complex according to Formula 2 and containing aluminum cation in the form substituted for resin emitted florescent light having peak wavelengths in between about 400 nm and about 450 nm and in between about 400 nm and about 450 nm and in between about 625 nm and about 675 nm. The intensity of the fluorescence was between 1500 a. u. and 2000 a.u.

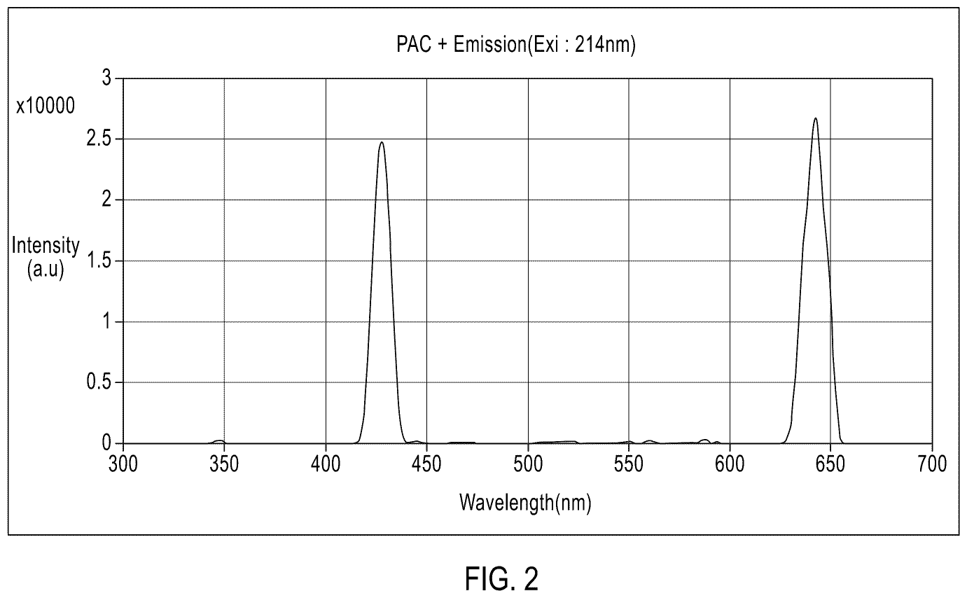

FIG. 2 illustrates a graph indicating a degree of light intensity emitted by printing material particles (y-axis) as printing material particles including 0.5 weight percent (%) of a metal-salen complex compound, with respect to the weight of the printing material particle, within the of the printing material particles both as an ingredient in the form substituted for resin, versus a range of light wavelength as indicated on the x-axis, when the printing material particles including the metal-salen complex compound within the shell layers absorb or are excited by the UV light having its peak wavelength of about 214 nm, according to an example. The intensity of the fluorescence was about 2500 a.u. or more, or in between 3000 a.u. and 2000 a.u.

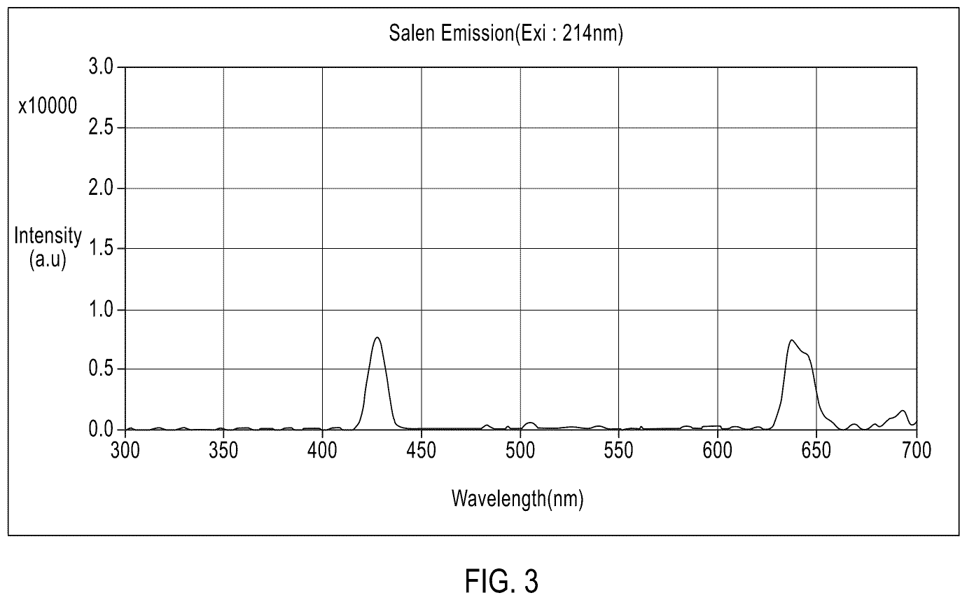

FIG. 3 illustrates a graph indicating a degree of light intensity emitted by printing material particles (y-axis) as printing material particles including a metal-salen complex compound as an external surface additive adhered or attached onto the external surfaces of the printing material particles, versus a range of light wavelength as indicated on the x-axis, when the printing material particles including the metal-salen complex compound adhered or attached onto the external surfaces of the printing material particles within the shell layers absorb or are excited by the UV light having its peak wavelength of about 214 nm, according to an example.

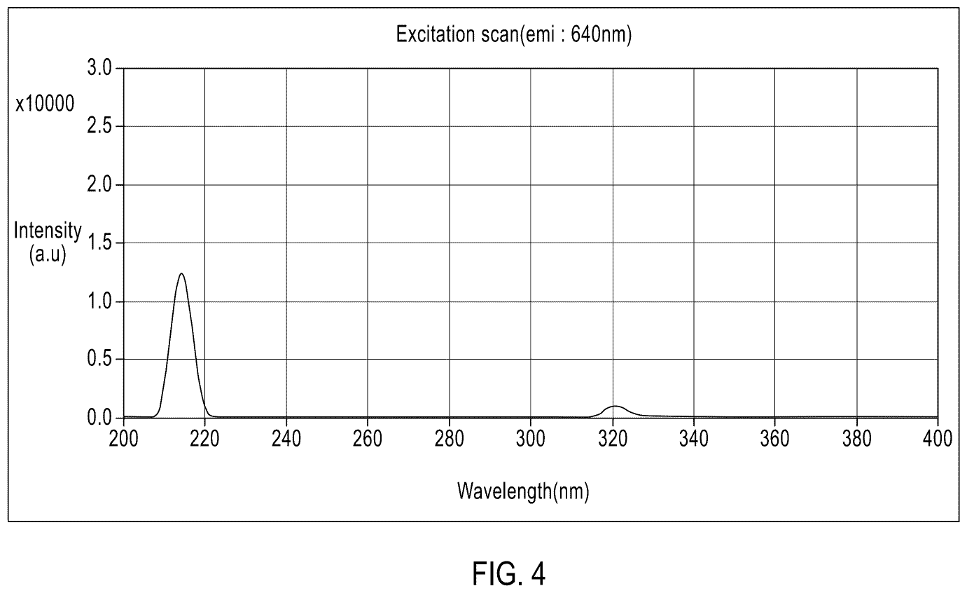

FIG. 4 illustrates a graph indicating a degree of light intensity at the peak wavelength of about 640 nm emitted by printing material particles (y-axis) as printing material particles including a metal-salen complex compound within the core particles of the printing material particles, versus when the printing material particles including the metal-salen complex compound within the core particles absorbs or is excited by different peak light wavelengths ranging from about 200 nm to about 400 nm as indicated on the x-axis.

Example solutions to measure the fluorescent intensities of Examples 1-9 and Comparative Examples 1˜4 were prepared by dissolving 0.25 grams of the dried corresponding example printing materials in 5 ml solvent (Ethanol:Acetone=4:1, by volume), putting the example solutions under sonification for about five minutes, and filtering the example solutions. The fluorescent intensities of Examples 1-9 and Comparative Examples 1˜4 were measured using PERKIN-ELMER FL6500 device based on the measurement conditions indicated in Table 1 Below:

TABLE 1

| Measurement Temperature | room temperature | |
|---|---|---|
| Light Source | Xenon lamp | |
| Excitation wavelength scan | about 214 nm, about 320 nm | |
| Excitation Slit Width | about 5 mm | |
| Emission Wavelength scan | From about 300 nm | |
| | to about 700 nm | |
| Emission Slit Width | 5 | mm |
| Acquisition Photomultiplier | 550 | V |

| | |
|---|---|
| Tube (PMT) Voltage | |
| PMT Gain | X1 |

Table 2 below indicates conditions measurement of Examples 1 through 8 and Comparative Examples 1 through 4

TABLE 2

| | | Amount of metal- | |
|---|---|---|---|
| | | salen complex | Intensity of |
| | | compound added | fluorescent |
| | | (unit: wt. % of | light measured |
| | | metal salen | (unit: arbitrary |
| | | complex with | unit (“a.u.”) |
| | | respect to | and other |
| | Type and location of | weight of printing | observation if |
| | material | material particle) | any |
| Example 1 | Metal-salen complex | about 0.5 | More than |
| | compound within | | about 1000 |
| | printing material | | and less than |
| | core particle | | about 10000 |
| Example 2 | Metal-salen complex | about 1.0 | More than |
| | compound within | | about 10000 |
| | printing material | | |
| | core particle | | |
| Example 3 | Metal-salen complex | about 1.5 | More than |
| | compound within | | about 10000 |
| | printing material | | |
| | core particle | | |
| Example 4 | Metal-salen complex | about 2.0 | More than |
| | compound within | | about 10000 |
| | printing material | | |
| | core particle | | |
| Example 5 | Metal-salen complex | about 2.5 | More than |
| | compound within | | about 10000 |
| | printing material | | |
| | core particle | | |
| Example 6 | Metal-salen complex | about 0.5 phr | More than |
| | compound within | within printing | about 10000 |
| | printing material | material core | |
| | core particle and | particle and about | |
| | added as external | 0.5 phr as | |
| | additive | external additive | |
| Example 7 | Metal-salen complex | about 0.1 | More than |
| | compound added as | | about 1000 |
| | external additive | | and less than |
| | | | about 10000 |
| Example 8 | Metal-salen complex | 0.5 | More than |
| | compound added as | | about 1000 |
| | external additive | | and less than |
| | | | about 10000 |
| Comparative | No Metal-salen | Not added | Less than |
| Example 1 | complex compound | | about 1000 |
| | added | | |
| Comparative | EDTA instead of | Not added | Less than |
| Example 2 | Metal-salen complex | | about 1000 |
| | compound, within | | |
| | printing material | | |
| | core particle | | |
| Comparative | Metal-salen complex | 0.6 | More than |
| Example 3 | compound added as | | about 10000; |
| | external additive | | Contamination |
| | | | on printing |
| | | | material |
| | | | transfer |
| | | | system |
| | | | occurred. |
| Comparative | Metal-salen complex | 3.0 | More than |
| Example 4 | compound within | | about 10000; |
| | printing material | | Unstable |
| | core particle | | printing |
| | | | material |
| | | | storage, such |
| | | | as being |
| | | | clumped |
| | | | together |

Referring to the results in Table 2, as in Example 1, when the amount of the metal-salen complex within the particle was equal to about 0.5 wt. % with respect to the weight of the printing material particle, the intensity of fluorescence was more than about 1000 a. u. and less than about 10000 a. u. When the amount of the metal-salen complex within the particle was equal to or more than about 1.0 wt. % with respect to the weight of the printing material particle, the intensity of fluorescence unexpectedly increased to more than about 10000 a. u. When the amount of the metal-salen complex within the particle was equal to or more than about 2.5 wt. % with respect to the weight of the printing material particle, some undesirable property was observed such as particle stability. When the amount of the metal-salen complex within the particle was equal to 3.0, wt. % with respect to the weight of the printing material particle, some undesirable property was excessively observed. For example, particle storage stability was affected, for example, due to a clumping effect.

When the amount of the metal-salen complex added as an external additive was from about 0.1 wt. % to 0.5 wt. % with respect to the weight of the printing material particle, the intensity of fluorescence was more than about 1000 a. u. and less than about 10000 a. u. When the amount of the metal-salen complex added as an external additive was equal to or more than about 0.6 wt. % with respect to the weight of the printing material particle, the surface characteristics changed, which may cause image forming system contamination.

As used in this disclosure, the words “a,” “an” and “the” are intended to include plural forms of elements unless specifically referenced as a single element. The term “at least” preceding a listing of elements denotes any one or any combination of the elements in the listing. In other words, the expression “at least one of . . . ” when preceding a list of elements, modifies the entire list of elements and does not modify the individual elements of the list.

While this disclosure has been shown and described with reference to examples thereof, it will be understood by one of ordinary skill in the art that various changes in form and details may be made therein without departing from the scope as defined by the claims.

What is claimed is:

1. A printing material particle comprising:
a colorant,
a binder resin, and
a metal-salen complex compound to absorb ultra-violet (UV) light to emit visible light to be fluorescent.

2. The printing material particle according to claim 1, wherein the metal-salen complex compound has Schiff base moiety.

3. The printing material particle according to claim 2, wherein the metal-salen complex compound has a molecular structure as follows: 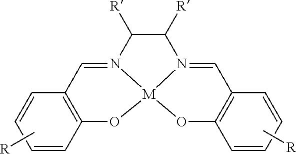
where:
M represents Al, Fe, Mg, or Zn;
R each represents, a hydrogen atom, an alkyl group, an alcohol group, a carboxyl group, or an ester group; and
R′ each represents a hydrogen atom, an alkyl group, an alcohol group, a carboxyl group, or an ester group.

4. The printing material particle according to claim 1, wherein the metal-salen complex compound is embedded in the printing material particle.

5. The printing material particle according to claim 1, wherein the metal-salen complex compound is attached on a surface of the printing material particle.

6. The printing material particle according to claim 4, wherein an amount of the metal-salen complex compound embedded within the printing material particle is equal to or more than about 0.5 weight percent (wt. %) and less than about 3.0 wt. % of the metal-salen complex compound with respect to weight of the printing material particle.

7. The printing material particle according to claim 5, wherein an amount of the metal-salen complex compound embedded within the printing material particle is equal to or more than about 0.1 weight percent (wt. %) and less than about 0.6 wt. % of the metal-salen complex compound with respect to weight of the printing material particle.

8. The printing material particle according to claim 1, wherein the metal-salen complex compound is to absorb the ultra-violet (UV) light having a peak wavelength in a first wavelength range of from about 200 nm to about 230 nm, to emit the visible light.

9. The printing material particle according to claim 1, wherein the metal-salen complex compound is to absorb the ultra-violet (UV) light to emit the visible light having a peak wavelength in a second wavelength range of from about 400 nm to about 450 nm or a third wavelength range of from about 625 nm to about 675 nm.

10. A cartridge couplable to an apparatus, the cartridge comprising:
a printing material to form an image, the printing material including a binder resin and a metal-salen complex compound to absorb ultra-violet (UV) light to emit visible light to be fluorescent.

11. The printing material according to claim 10, wherein the metal-salen complex compound has a molecular structure as follows: 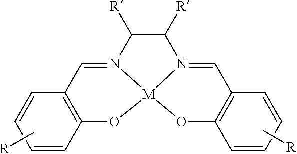
where:
M represents a metal cation;
R each represents, a hydrogen atom, an alkyl group, an alcohol group, a carboxyl group, or an ester group; and
R′ each represents a hydrogen atom, an alkyl group, an alcohol group, a carboxyl group, or an ester group.

12. The printing material particle according to claim 10, wherein the metal-salen complex compound is embedded in the printing material particle.

13. The printing material particle according to claim 12, wherein an amount of the metal-salen complex compound embedded within the printing material particle is equal to or more than about 0.5 parts by weight and less than about 3.0 parts by weight of the metal-salen complex compound per 100 parts by weight of the binding resin.

14. The printing material particle according to claim 10, wherein
the metal-salen complex compound is attached on a surface of the printing material particle, and
an amount of the metal-salen complex compound embedded within the printing material particle is equal to or more than about 0.1 parts by weight and less than about 0.6 parts by weight of the metal-salen complex compound per 100 parts by weight of the binding resin.

15. An apparatus comprising:
a device to print using printing material, the printing material including a metal-salen complex compound to absorb ultra-violet (UV) light to emit visible light to be fluorescent.
